(19) United States
(12) Patent Application Publication
(10) Pub. No.: US 2022/0234697 A1
(43) Pub. Date: Jul. 28, 2022

(54) A FLOATING STRUCTURE AND METHOD OF INSTALLATION

(71) Applicant: Ægir Harvest AS, Trondheim (NO)

(72) Inventors: Ole Petter HJELMSTAD, Trondheim (NO); Jon Ove LUNDE, Sandvika (NO)

(21) Appl. No.: 17/612,458

(22) PCT Filed: May 18, 2020
(86) PCT No.: PCT/NO2020/050126

§ 371 Date: Nov. 18, 2021

(30) Foreign Application Priority Data
May 21, 2019 (NO) 2019 0637

(51) Int. Cl. B63B 35/44; B63B 77/10; B63B 21/50; F03D 13/25

(52) U.S. Cl. CPC B63B 35/44; B63B 77/10; F05B 2240/93; F03D 13/25; B63B 2035/446; B63B 21/502

(57) ABSTRACT

A system comprises a carrier structure configured for carrying a module and a floating support structure configured for supporting the carrier structure. The carrier structure comprises first connection means and the floating support structure comprises second connection means, whereby the first and second connection means are configured for releasable connection and comprise contact surfaces that prevent the carrier structure from rotating about its longitudinal axis when the two structures are connected. A transportation and installation apparatus for the carrier structure is configured for being arranged on a floating vessel.

### TECHNICAL FIELD

The present invention relates to floating structures that are configured for carrying a module or other devices above a body of water, and to associated methods of installation. The module may for example be a wind turbine.

### BACKGROUND

Demand in electricity generation is expected to greatly increase in the future. There is also a strong push towards renewable forms of electricity generation. Most of the world's largest cities are located near a coastline. Thus, wind power is suitable for large-scale developments near major demand centers. Onshore development of power plants in these areas will however be costly due to high property prices. Furthermore, there is frequent public opposition to onshore developments due to noise, visual pollution, and other factors. This is also the case for offshore wind farms that are visible from shore. Most wind resources practically explorable offshore are beyond reasonable limits for bottom-fixed turbines.

Floating wind is currently expensive compared to on-shore and bottom fixed offshore wind farms. Most of the currently known floating wind platform concepts use very large and expensive foundations. The wind turbines are mounted to the platforms using large on-shore cranes or floating cranes. After assembly, the platforms are towed off-shore one by one and anchored to the seabed. For bottom-fixed offshore wind farms, the foundations are transported offshore and driven into the seabed, and the wind turbines are mounted on the foundations using very large offshore crane vessels. Off-shore heavy lifting is both very complex and expensive.

Maintenance of current floating wind platforms are also very expensive as it is either required to tow the platform back to shore to get access to on-shore cranes or use the complex and expensive off-shore heavy lifting cranes.

Based on the above, there is a need for a floating wind platforms that are less expensive to manufacture, install and replace.

The prior art includes US 2012103244 A, which describes a truss cable semi-submersible floater for offshore wind turbines. A floating system includes a hull, a tensioned cable system, and a tower. The hull includes vertical buoyant columns with one column at the center, larger size column base tanks, and a truss system, all of which are coupled to each other for supporting the tower and wind turbines. The tensioned cable system including upper, lower, and diagonal tensioned cables to connect the column, the column base, and the tower to reduce the bending moments and improve stability, strength and dynamic performance of the hull structure.

The prior art also includes US 2013019792 A, which describes a floating structure having an annular support as an underwater support with a buoyant body. A tower penetrates the annular support centrally and is connected to the annular support at a location underneath the annular support by slantedly outwardly ascending tension spokes and at a location above the annular support by slantedly outwardly descending tension spokes.

The prior art also includes US 2012255478 A, which describes a ship for conveying and setting up offshore structures. The ship comprises a hull with a U-shaped cross-section having an open stern and projections of the side walls extending at the rear beyond the rear edge of the floor, jack-up leg systems with jack-up legs integrated in the hull that are movable in a vertical direction with their bottom ends in positions below the floor, and a crane that can move on the top edges of the side walls.

The prior art also includes US 2013233231 A, which describes a semisubmersible wind turbine platform capable of floating on a body of water and supporting a wind turbine over a vertical center column. A vertical center column and three or more vertical outer columns are spaced radially from the center column, each of the outer columns being connected to the center column with one or more of bottom beams, top beams, and struts, with the major structural components being made of concrete and having sufficient buoyancy to support a wind turbine tower.

### SUMMARY OF THE INVENTION

A goal with the present invention is to overcome the problems of prior art, and to disclose a system and a method.

The invention is set forth and characterized in the main claims, while the dependent claims describe other characteristics of the invention.

It is thus provided a system comprising a carrier structure configured for carrying a module, and a floating support structure configured for supporting the carrier structure, wherein the carrier structure comprises first connection means and the floating support structure comprises second connection means, characterized in that the first and second connection means are configured for releasable connection and comprise contact surfaces that prevent the carrier structure from rotating about its longitudinal axis when the two structures are connected. In one embodiment, the first connection means comprises a plurality of first receptacles and a second connection element, and the second connection means comprises a second receptacle and a plurality of support members, and wherein the second receptacle is configured for receiving the second connection element and the first receptacles are configured for receiving a corresponding one of the support structures.

In one embodiment, the second connection element is arranged on a portion which is dimensioned such that, when mating the carrier structure and the support structure, the second connection element is received in the second receptacle before the support posts are received in the first receptacles. The support structure may comprise connection elements for one or more tethers, whereby the support structure may be moored to a seabed as a tension-leg platform (TLP).

In one embodiment, a first connection element is arranged on the carrier structure and shaped and dimensioned for releasable connection to a transportation and installation apparatus. The carrier structure may be a wind turbine tower and the module may be a generator and wind turbine.

It is also provided a transportation and installation apparatus, configured for being arranged on a floating vessel, characterized by a housing comprising one or more holding bays configured for releasably holding a carrier structure according to the invention; a motion compensation mechanism configured for moving the housing with respect to the vessel about at least a pitch axis and a roll axis, and vessel heave. A holding bay is shaped and dimensioned for receiving a first connection element on a carrier structure. A holding bay may comprise a holding device whereby a carrier structure may be pulled into and secured in the holding bay.

It is also provided a method of installing the carrier structure and the floating support structure according to the invention, characterized by:
transporting one or more floating support structures to an installation location and mooring it to a seabed by a plurality of tethers, whereby the floating support structure becomes a tension-leg platform (TLP);
transporting one or more carrier structures to the installation location by means of the transportation and installation apparatus according to the invention;
positioning a carrier structure above a tethered support structure by means of the transportation and installation apparatus and operating it to lower the carrier structure into mating engagement with the support structure.

The invention provides a novel and inventive approach to offshore windfarming technology. The carrier structure (e.g. a wind turbine tower) and the floating support structure may be fabricated, assembled, outfitted, and commissioned as separate units at an onshore location and transported individually to the offshore installation site, where the two are mated. Several support structures may be towed by regular towing vessels (or transported on a barge). A purpose-built transportation and installation apparatus may carry two wind turbine towers at a time. A transport vessel may have more than one transportation and installation apparatus.

One advantage in towing the support structure to the offshore location as a separate module—not carrying the wind turbine tower, is that the support structure in this configuration displays motions characteristics comparable to that of a semi-submersible platform during tow. When the support structure has been tethered to the seabed at the offshore location and the wind turbine tower and support structure have been mated, the support structure displays motion characteristics comparable to that of a tension-leg platform (TLP). TLP motion characteristics are more favorable for a wind power plant than those of a semi-submersible platform. While a semi-submersible platform is movable in all six degrees of freedom, the TLP normally exhibits a pendulum-like movement pattern. A TLP is therefore a better choice of platform for a wind turbine, as the nacelle and turbine are not exposed to large accelerations.

### BRIEF DESCRIPTION OF THE DRAWINGS

These and other characteristics of the invention will become clear from the following description of embodiments of the invention, given as non-restrictive examples, with reference to the attached schematic drawings, wherein:

FIG. 1 is a perspective view of a first embodiment of the carrier structure according to the invention, here in the form of a wind turbine tower;

FIG. 2 is an enlarged view of the section marked “A” in FIG. 1, and illustrates a lower region of the carrier structure;

FIG. 3 corresponds to FIG. 2 in that is illustrates the same lower region of the carrier structure, but from a different perspective;

FIG. 4 is a perspective view of a first embodiment of the support structure according to the invention, here in the form of a floating support structure;

FIG. 5 is an enlarged view of the section marked “B” in FIG. 4, and illustrates a carrier structure interface portion;

FIG. 6 is a perspective view of an assembly and load-out process for a plurality of said support structures;

FIG. 7 is a perspective view of a tow-out operation for a plurality of said support structures;

FIG. 8 is a perspective view of a support structure according to the first embodiment of invention, in an installed state in a body of water;

FIG. 9 is a perspective view of an assembly and load-out process for a plurality of carrier structures according to the first embodiment of invention, here in the form of a plurality of wind turbine towers;

FIG. 10 is a perspective view of a first embodiment of the transportation and installation apparatus according to the invention, placed on a floating vessel;

FIG. 11 is an exploded view of an embodiment of the transportation and installation apparatus shown in FIG. 10, showing also an embodiment of a holding device, and illustrating axes and arrows indicating possible directions of movement;

FIG. 12 is a perspective view of a portion of the transportation and installation apparatus which is configured to connect to the carrier structure, also illustrating an embodiment of a holding device.

FIG. 13 is a perspective view of a portion of the transportation and installation apparatus, in a first state of connection to the carrier structure;

FIGS. 14 to 17 are perspective views of a mating procedure in which a carrier structure is placed on a support structure;

FIG. 18 is a perspective view of a second embodiment of the support structure according to the invention, here in the form of a tension leg platform (TLP) comprising a lower support structure;

FIG. 19 illustrates an embodiment of a wind turbine tower.

FIG. 20 illustrates an embodiment of a lower support structure.

FIG. 21 illustrates an embodiment of an upper support structure.

FIGS. 22a-22b illustrates methods of transporting the TLP offshore.

FIG. 23 illustrates an embodiment of a barge.

FIG. 24 illustrates an another exemplary embodiment.

FIG. 15 illustrates an embodiment of a method.

### DESCRIPTION OF EMBODIMENTS OF THE INVENTION

In the following description, various examples and embodiments of the invention are set forth in order to provide the skilled person with a more thorough understanding of the invention. The description may use terms such as “horizontal”, “vertical”, “lateral”, “back and forth”, “up and down”, “upper”, “lower”, “inner”, “outer”, “forward”, “rear”, etc. These terms generally refer to the views and orientations as shown in the drawings and that are associated with a normal use of the invention. The terms are used for the reader's convenience only and shall not be limiting. Also, the specific details described in the context of the various embodiments and with reference to the attached drawings are not intended to be construed as limitations. Rather, the scope of the invention is defined in the appended claims.

In general, the invention comprises a system of a floating support structure and a carrier structure, wherein the two structures may be fabricated, assembled, outfitted and commissioned on separate onshore locations, transported as separate entities to an offshore installation location, where the two structures are mated. In particular, fabrication and assembly of the carrier structure does not require a large area, and may be performed on a quay, utilizing existing facilities (cranes, etc.).

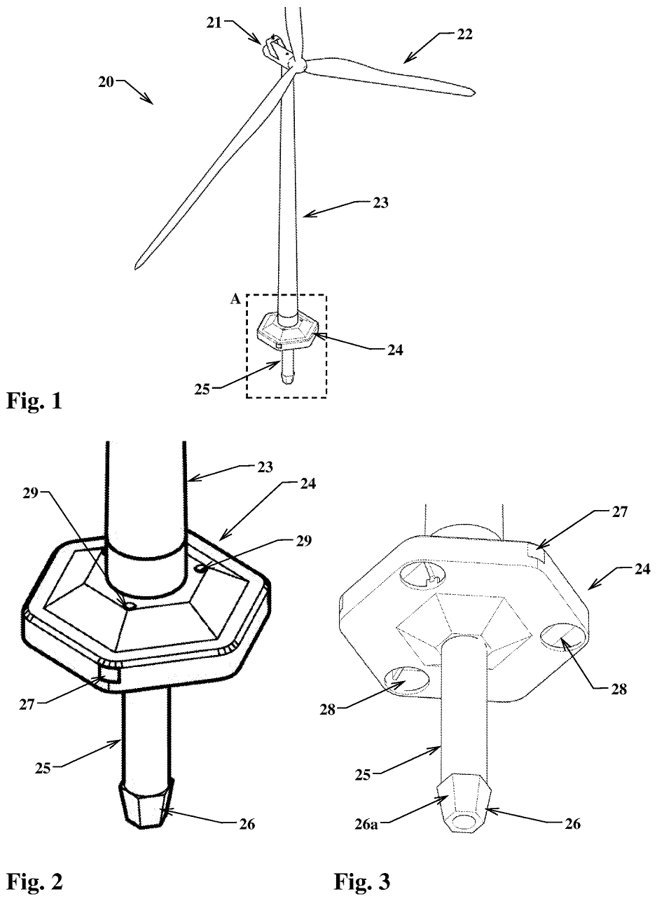

FIG. 1 illustrates a first embodiment of the carrier structure 20 according to the invention, here in the form of a wind turbine tower. The wind turbine tower 20 comprises a support column 23 which at its upper end supports a generator nacelle 21 and a turbine 22, as such known in the art. It should be understood that the column 23 may be configured to support other modules or devices, and the nacelle 21 and turbine 22 may in the following thus be referred to a module.

In the support column 23 lower region, two connection elements are arranged; a first (upper) connection element 24 and a second (lower) connection element 26 (see FIGS. 2 and 3). The two connection elements are separated by a column portion 25. These parts are connected to each other and to the support column by means and methods that are well known in the art and dimensioned for the intended purpose.

In the illustrated embodiment, the first connection element 24 has a disc shape or collar shape, and extends a radial distance out from the support column 23. For simplicity, the first connection element may therefore be referred to as a collar 24. The radial extension provides for a plurality of first receptacles 28 on the collar lower side. It should be understood that other shapes for the first connection element 24 are conceivable, as long as its diameter is sufficiently large to accommodate the first receptacles 28. The diameter of the collar 24 and the arrangement of the first receptacles 28 (e.g. their distance from the column and column portion) are determined for the specific intended purpose.

The collar 24 comprises at least one manhole 27, for providing access for personnel into the collar interior. Reference number 29 indicates transport and installation receptacles, the function of which is described in more detail below.

In the illustrated embodiment, the second connection element 26 comprises a frusto-conical stub with a plurality of surfaces 26a. In the illustrated embodiment, the second connection element 26 has a hexagonal outer profile. The purpose and function of the second connection element is described below.

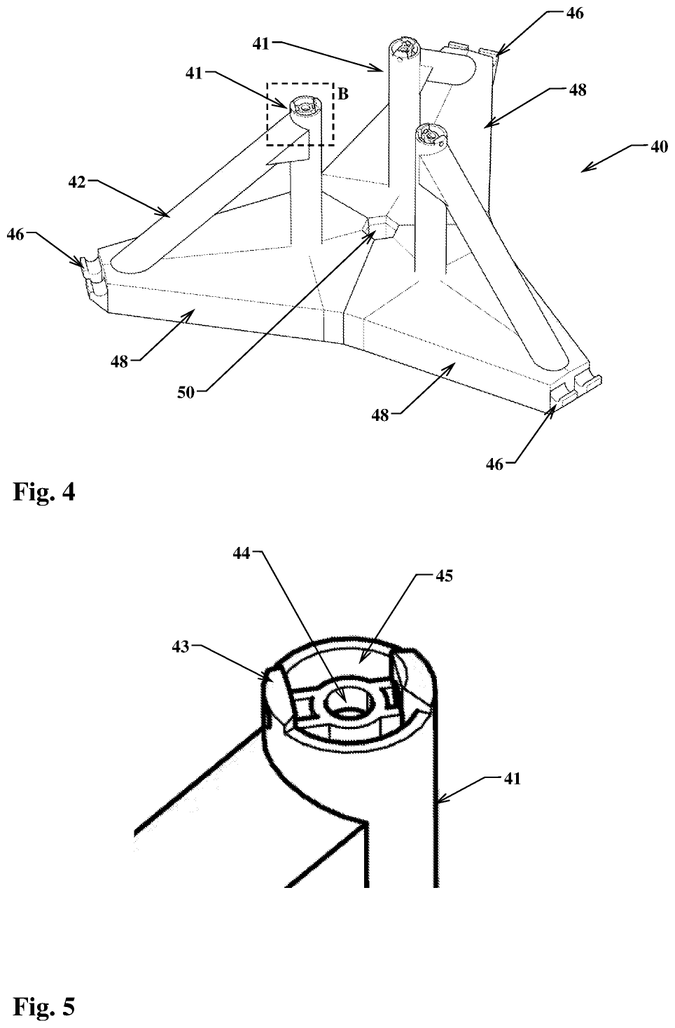

Referring to FIGS. 4 and 5, a first embodiment of the support structure 40 according to the invention comprises here a floating support structure 40 having three support members 41 in the form of support posts extending upwards from the support structure. It should be understood that the invention shall not be limited to this number of support posts 41. Each support post is provided with a support bracing member 42. Each support post 41 comprises at its upper end an interface portion 43 with a geometry which is configured and dimensioned to engage with a corresponding structure in a first receptacle 28 in the collar 24. The upper end of each support post 41 is thus configured for entering a corresponding first receptacle 28, and each first receptacle 28 has a shape and dimension which is complementary to the shape and dimension of a support post 41 upper end. The support posts 41 are hollow, having an internal conduit 45 for ballasting operations and a guide structure 44 for supporting I-tubes for electrical cables, etc.

The support structure 40 comprises internal ballast chambers (not shown), whereby the support structure 40 may be ballasted and de-ballasted in a manner which is well known in the art. Various inlet and outlet openings, pumps, valves, etc. are not illustrated.

The support structure 40 comprises a second receptacle 50, centrally arranged between the support posts 41. The second receptacle 50 has a shape and dimension which is complementary to the shape and dimension of the second connection element 26.

When the carrier structure 20 is mated with the support structure 40, the second connection element 26 is the initial object to contact the support structure, as is explained below. One purpose of the second connection element 26 and the corresponding second receptacle 50 is to prevent rotation around the support column central axis and to provide a guide (first contact) during mating. It should therefore be understood that any non-circular profiles that will prevent rotation are possible.

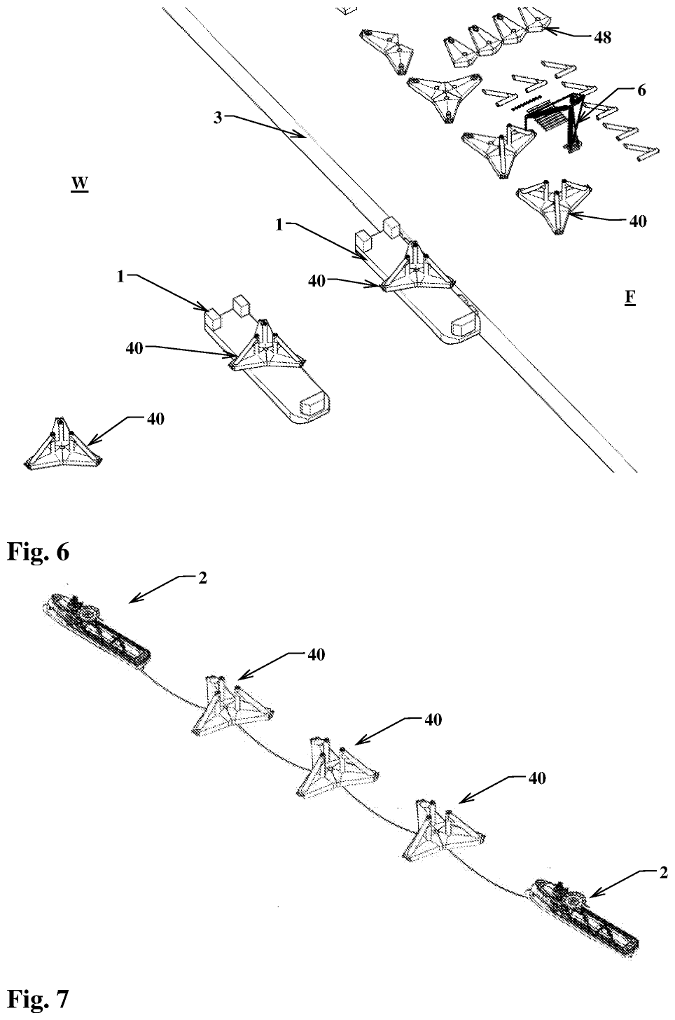

FIG. 6 illustrates an assembly and load-out process for a plurality of the support structures 40. Each support structure 40 is assembled at an onshore assembly facility F, and may be based on three identical support base elements 48. Upon completion and commissioning, each support structure 40 may be placed on a transport vessel at a quayside 3, and transported to the intended offshore installation location, or a plurality of support structures 40 may be towed to the installation location by tugs 2 (FIG. 7).

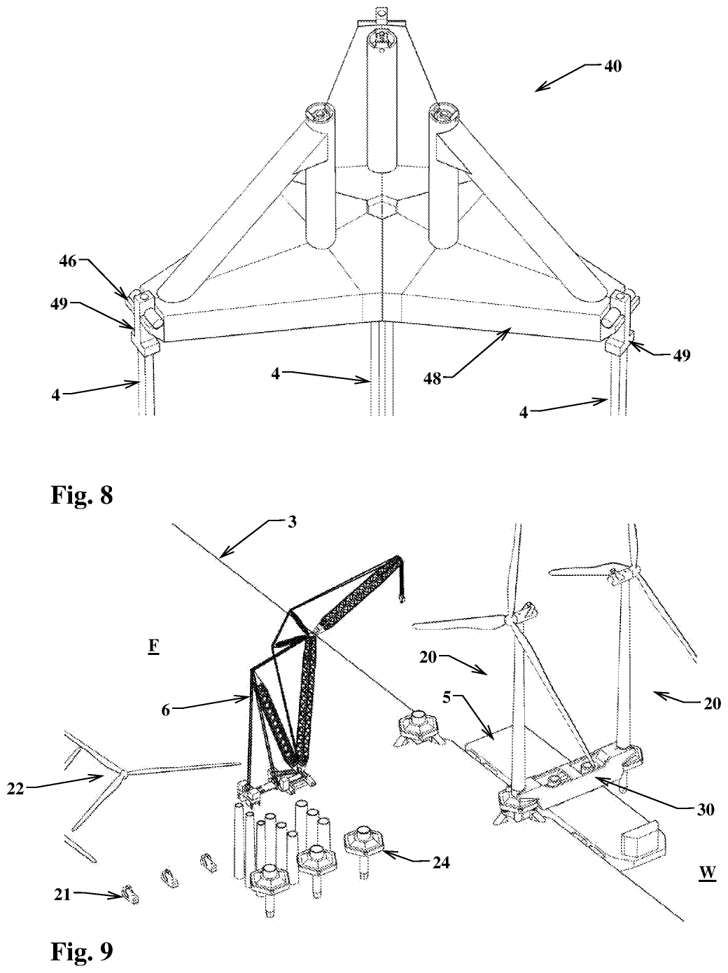

In FIG. 8, a support structure 40 has been installed in a body of water by means of tethers 4 connected to tether hang-off porches 46 via tether connection members 49. In the illustrated embodiment, each support base element 48 comprises a hang-off porch 46. The tethers 4 may be of a type which are used on conventional tension-leg platforms (TLPs), but are preferably of a flexible rope, such as fibre rope.

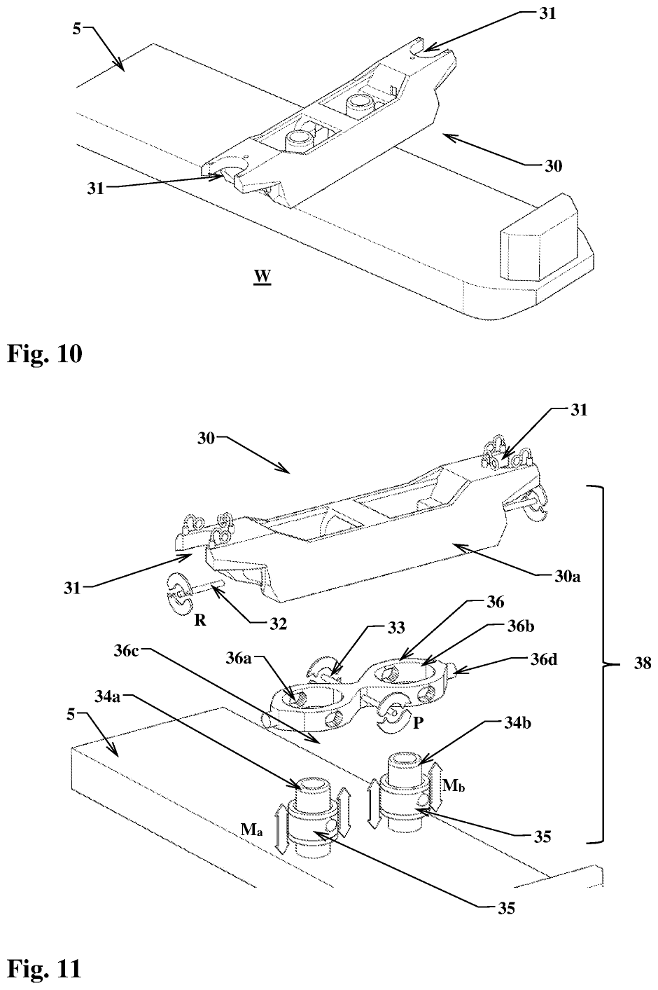

FIG. 9 illustrates a fabrication and load-out process for plurality of wind turbine towers 20 at an assembly facility F, in which the individual components are assembled by means of a crane 6 and placed on an installation vessel 5. The installation vessel 5 comprises a transportation and installation apparatus 30, an embodiment of which will be described in the following, with reference to FIGS. 10-12.

The transportation and installation apparatus 30 comprises a housing structure 30a having two holding bays 31, each bay extending beyond the vessel 5 such that it is arranged above the body of water W. Each holding bay 31 has a shape and dimension which is complementary to the shape and dimension of a portion of the carrier structure (wind turbine tower) 20, particularly that of the first connection element 24 and a portion of the support column 23. The transportation and installation apparatus may thus carry two complete wind turbine towers 20, one on each side of the vessel, as illustrated in FIG. 9.

The transportation and installation apparatus 30 is movably supported on the vessel 5 via a motion compensation mechanism 38. Two foundation posts 34a,b extend upwards from the vessel deck, and a sleeve 35 is movably connected to each post. The sleeves 35 may thus move up and down on its respective post, by means of a conventional jacking mechanism (not shown) or any other motive means. A gimbal element 36 is movably connected to the sleeves 35, via respective sleeve interface structures 36a,b. These structures comprise openings and pegs as shown in FIG. 11, such that movements Mₐ and M_{b} of the sleeves will cause the gimbal element 36 to rotate (pitch; P) about a pitch axis 33. As the gimbal element 36 is connected to the housing 30a (via pegs 36c,d), this pitching movement will be transferred directly to the housing 30a. The pegs 36c,d are rotatably connected to the housing 30a (connection means not shown) such that the housing may rotate (roll; R) about a roll axis 32 (which is perpendicular to the pitch axis). The housing 30a may therefore move about a roll axis and a pitch axis. In FIG. 11, the roll axis 32 extends through the oppositely arranged bays 31 and is also transverse to the vessel 5. The pitch axis 33 is arranged along the vessel longitudinal axis. Pumps, valves, actuators, etc. that are required to operate the motion compensation mechanism 38 are not illustrated, as such components are well known in the art. It should be understood that the housing 30a may be moved about the pitch and roll axes by other motion compensation mechanisms than the one illustrated in FIG. 11.

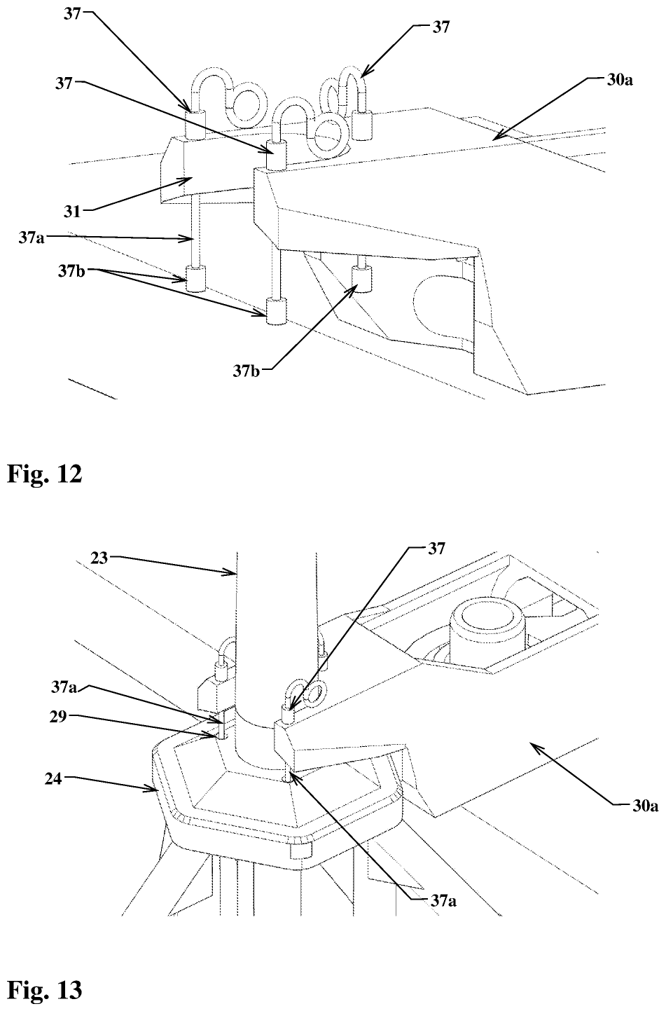

As mentioned above, each holding bay 31 has a shape and dimension which is complementary to the shape and dimension of the first connection element (collar) 24 and a portion of the support column 23. In the illustrated embodiment, the hexagonal shape of the collar 24 (see e.g. FIGS. 2 and 3) matches a complementary shape inside the bay 31 (not shown in full detail) and the curved shape of the bay matches the complementary circular shape of the support column 23. It should be understood that other shapes are conceivable as long as the shapes contribute to holding the carrier structure in the bay without rotation about the support column longitudinal axis. The carrier structure is lifted into, held in position, and released from the holding bay 31 by a holding device, an embodiment of which is described in the following with reference to FIGS. 12, 13, and 14. In this embodiment, the holding device comprises three strand jacks 37 which per se are known in the art. Each strand jack comprises a wire bundle 37a and a connection member 37b. When connecting the wind turbine tower to the holding bay 31, the connection members 37b are lowered into corresponding transport and installation receptacles 29 on the collar 24, where they are releasably locked in a manner which per se is known in the art. The wind turbine tower is then hoisted by the strand jack wire bundles 37a until the collar 24 abuts against its complementary structure in the holding bay 31. The procedure is reversed when the wind turbine tower is to be released from the bay, for example in a mating procedure at an offshore installation location.

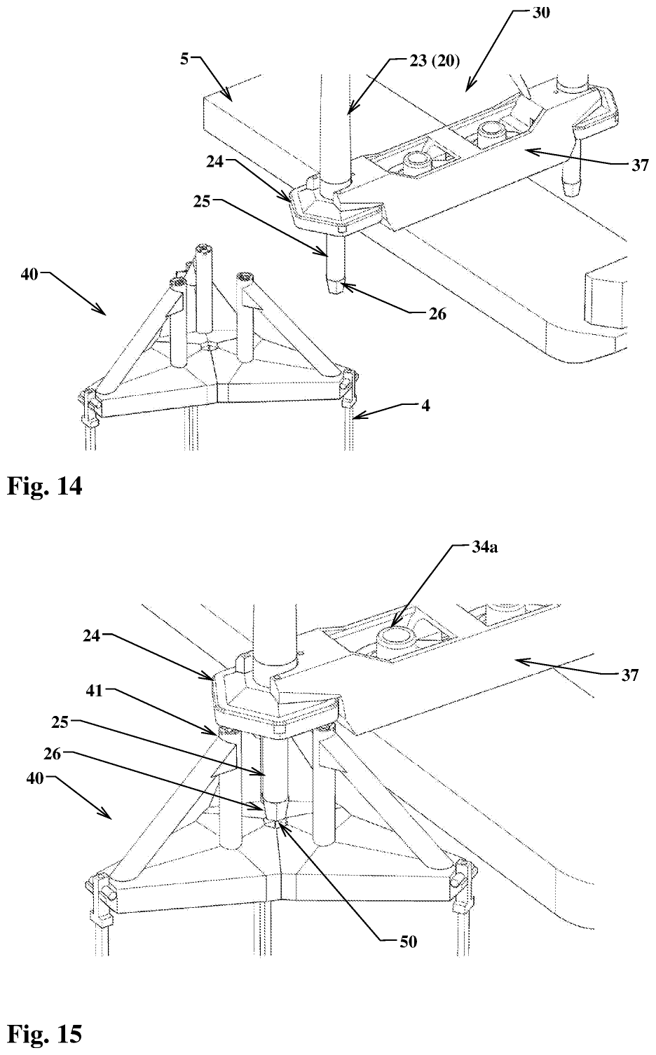

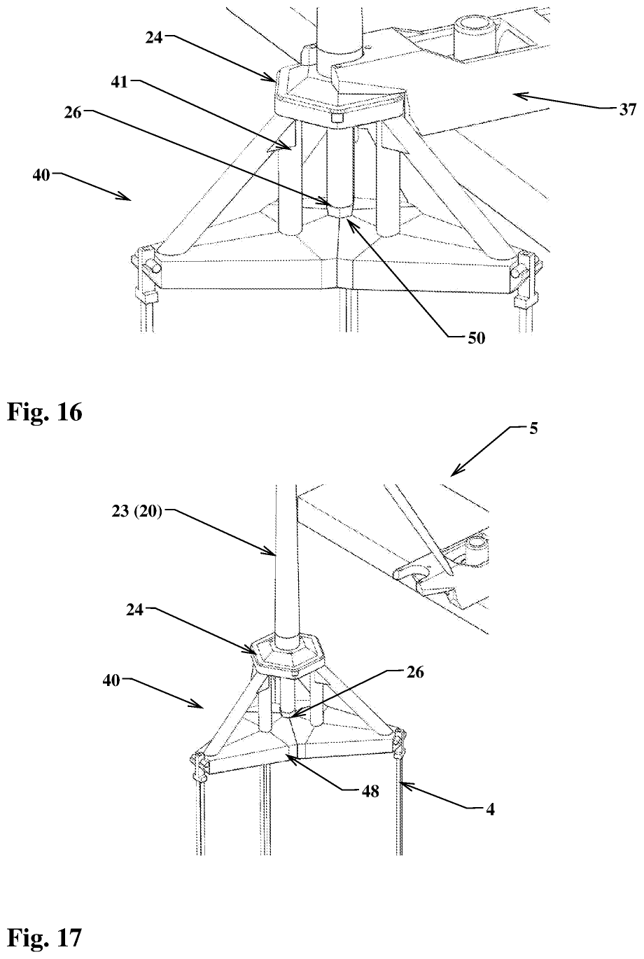

A procedure for mating the wind turbine tower (carrier structure) 20 to the support structure 40 will now be described with reference to FIGS. 14 to 17. In these figures, the transportation and installation apparatus 30 is illustrated without the strand jacks 37 described above, as it should be understood that any suitable holding device may be used.

In FIG. 14, the vessel 5, carrying two wind turbine towers, has arrived at the installation location where a floating support structure 40 has been installed as described above. It should be understood that the mating procedure applies to also a support structure which is supported by other means, such as a firm foundation on the seabed or on dry land.

In FIG. 15, the wind turbine tower has been lowered towards the support structure 40. The combination of the second connection element 26 and the column portion 25 is longer than the height of the support posts 41, whereby the second connection element 26 enters the second receptacle 50 before the collar 24 (with the first receptacles 28) lands on the support posts 41. The non-circular shapes of the second connection element 26 and the corresponding second receptacle 50 ensures that the first receptacles 28 are properly aligned with their respective support post 41 before making the connection. The lowering procedure is performed by lowering the transportation and installation apparatus 30 with respect to the vessel 5 deck, by lowering the holding devices (e.g. strand jacks 37, described above), or a combination of both. The motion compensation mechanism 38 may be actively operated to ensure proper alignment between the carrier structure 20 and the support structure 40 during the mating procedure.

Removal of the carrier structure 20 is performed in a reversed sequence, in which the winch-and-connection device is connected to the collar and the structure is pulled into the holding bay 31 (similar procedure to the load-out procedure described above).

Although the invention has been described above with the first receptacles 28 and the second connection element 26 being a part of the carrier structure 20, and the support posts 41 the second receptacle 50 being a part of the support structure 40, it should be understood that a reverse configuration is conceivable. That is, the second receptacle and support posts may be arranged on the carrier structure and the first receptacles and second connection element may be part of the support structure.

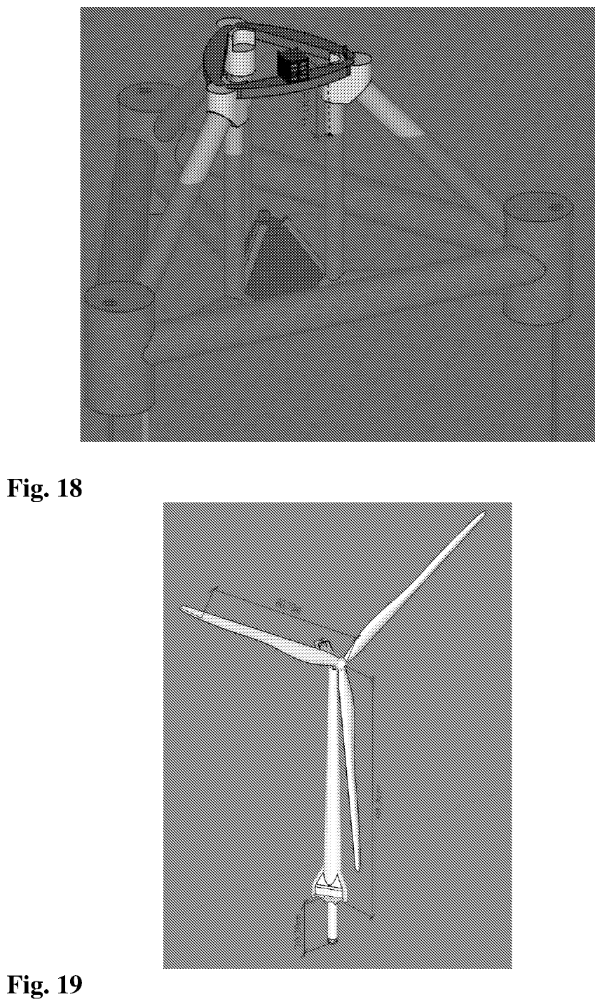

A second embodiment of the invention will now be described with reference to FIGS. 18 to 25.

With reference to FIGS. 18 and 19, the invention in the second embodiment comprises a floating wind turbine platform, in the illustrated embodiment comprising a floating support structure in the form of a tension leg platform (TLP) 400. The TLP 400 comprises a lower support structure in the form of a lower receptacle 500 adapted to receive a lower end of a wind turbine tower under the water surface. The platform comprises in the illustrated embodiment three tubulars connected to form a regular triangle as shown in FIG. 18. A tank is provided on each of the vertices of the triangle. The tubulars and the tanks provide buoyancy. As a non-limiting example, the platform illustrated in FIG. 18 has a weight of approximately 2500 tonnes and a displacement of approximately 6000 m³. The length of each side of the triangle is approximately 60 m and the height of the platform is approximately 31 m. The invention shall, however, not be limited to this geometry and these dimensions.

Now also with reference to FIG. 19, the lower support structure comprises in the illustrated embodiment a plurality of contact surfaces corresponding to a plurality of contact surfaces on the lower end of the wind turbine tower. An effect of these corresponding surfaces is that the wind turbine tower is restricted from rotation. Furthermore, a tight fit between the wind turbine tower and the low support structure is ensured by gravity, i.e. the weight of the wind turbine tower working against the contact surfaces of the lower support structure. An effect of this feature is that no bolting or welding is required for fastening the wind turbine tower. This reduces cost and complexity of installation, in particular when installing the wind turbine tower offshore.

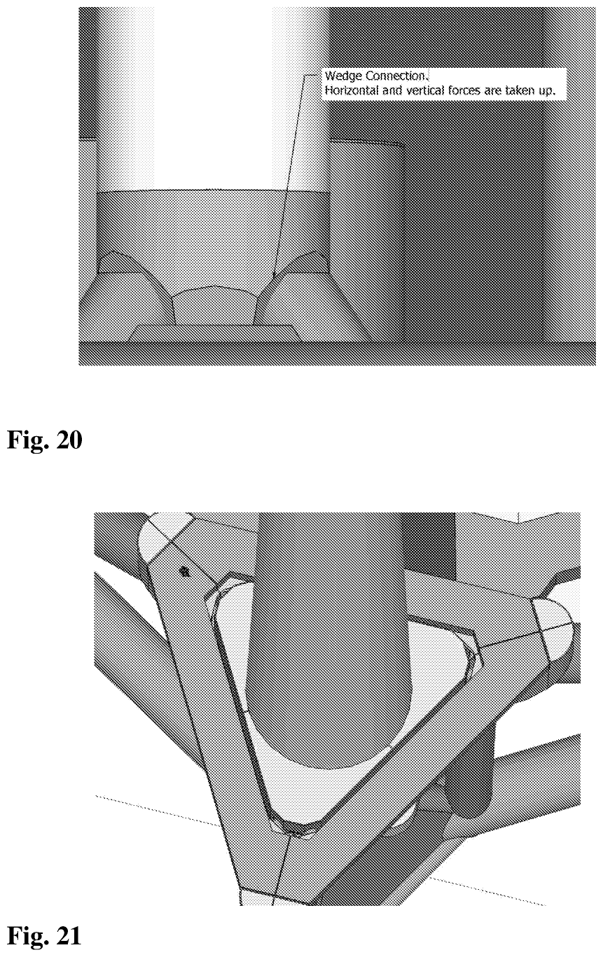

With reference to FIG. 20, in one embodiment the lower support structure comprises a plurality of wedge shaped contact surfaces, the wedge shaped contact surfaces adapted to receive wedge shaped contact surfaces at the lower end of the wind turbine tower. The wedge shaped contact surfaces of the lower structure take up both horizontal and vertical forces.

With reference to FIG. 18, in one embodiment the platform may comprise an upper support structure adapted to surround and support the wind turbine tower. At least one section of the upper support structure may be adapted to be removed to install or remove the wind turbine tower. Thus, in the illustrated embodiment, the upper support structure comprises three beams that may be lifted and temporarily removed. When at least one of the beams are removed, it is possible to enter the wind turbine tower onto the lower support structure into the center for the TLP without the need for offshore heavy lift cranes.

The wind turbine tower may be installed on the platform positioned in the TLP with the use of an outrigger on a barge or a semi-submersible vessel. In the illustrated embodiment, the platform may be accessed from all of the sides of the triangle as each of the beams may be removed separately and independently of each other. The remaining two beams maintain the rigidity of the structure during mounting. With reference to FIG. 19, it is shown that a part of the wind turbine tower is adapted to fit inside the upper support structure. The upper support structure only horizontal forces. No bolting or welding required for fastening tower to the upper support structure.

With reference to FIG. 21, in one embodiment, spacers may be provided between the wind turbine tower and the upper support structure. The spacers may be pushed out by hydraulic means, e.g. remotely controlled from an installation vessel, or input by other means. The spacers may be used to adjust the upright position of the wind turbine tower during installation. The spacers also provides a damping effect between the wind turbine tower and the upper support structure. An effect of the spacers is to mitigate cyclic loads from the wind turbine tower that may deteriorate welds and bolts. In one embodiment, the spacers are made of an elastic material, such as rubber.

In one embodiment, the wind turbine tower may comprise an upper support structure adapted to surround and support the wind turbine tower, wherein the upper support structure is adapted to be received in the TLP. The upper support structure of this embodiment is identical to the upper support structure of the TLP, but mounted on the wind turbine tower.

In the illustrated embodiments, the upper support structure is triangular, however, other shapes is possible, such as square, pentagonal, hexagonal etc.

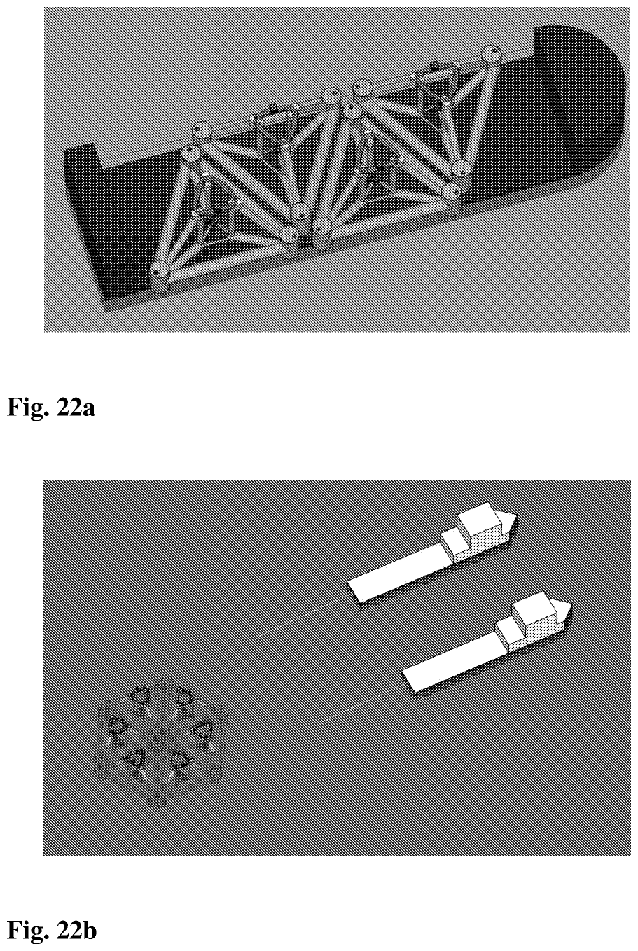

The floating wind turbine platform is manufactured on-shore and transported into the field off-shore without the wind turbine tower. FIG. 22a illustrate transport of a plurality of the floating wind turbine platforms using a semi-submersible transport vessel. FIG. 22b illustrate transport of a plurality of the floating wind turbine platforms towed as an interconnected group. The floating wind turbine platforms may be stored inshore in groups of interconnected platforms.

The TLP is transported offshore to a deployment position where anchor lines have been pre-installed. The TLP is ballasted down by pumping water into the ballast tanks prior to connection to the anchor lines. After connection to the pre-installed anchor lines, the water tanks are de-ballasted to operational draft, thus tensioning the anchor lines.

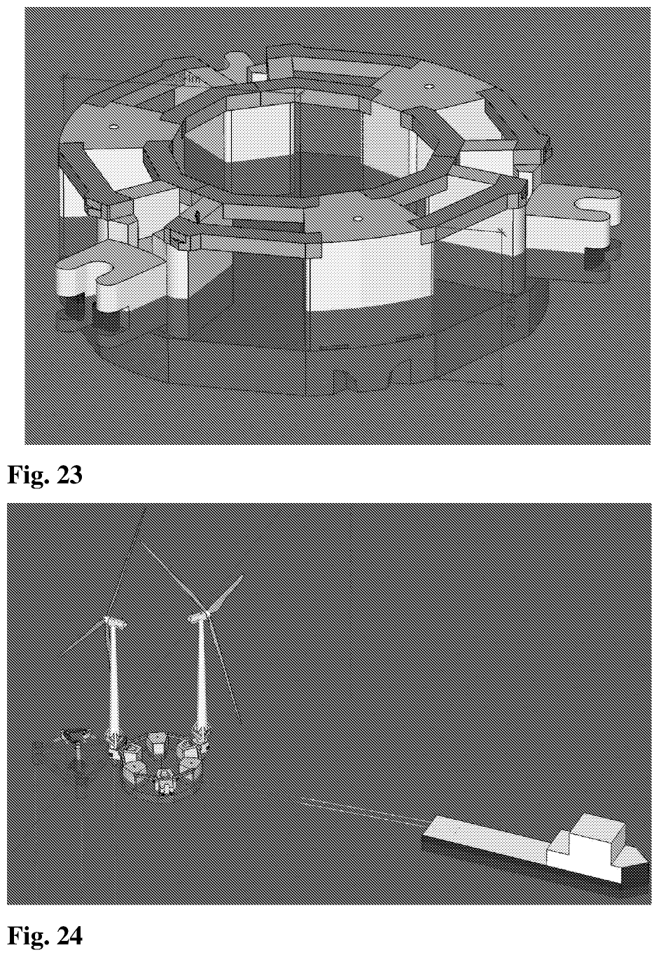

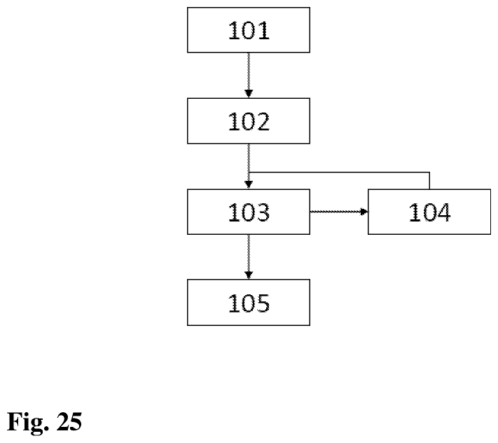

With reference to FIG. 23, the invention in the illustrated embodiment is a vessel for mounting a wind turbine tower on a floating wind turbine platform, comprising a holding means adapted to hold the barge against the floating wind turbine platform, at least one outrigger adapted to position a lower end of a wind turbine tower in a lower support structure of a tension leg platform (TLP) under the water surface, and at least one ballast tank adapted to ballasting the vessel as the weight of the wind turbine tower is transferred to the floating wind turbine platform. In one example, as illustrated in FIG. 24, the vessel simultaneously carries at least two wind turbine towers, preferably three wind turbine towers. The vessel may be a barge, an autonomous vessel, a remotely controlled vessel, or a conventional construction vessel.

In one embodiment, the outrigger may be provided with a jacking means to lower and or heist the wind turbine tower into or out from the lower support structure. The jacking means may have a movement range of approximately 2-4 m.

In one embodiment, the vessel may be provided with a plurality of contact points adapted to contact a plurality of corresponding contact points on the floating wind turbine platform. An effect of the contact points is to reduce and control relative movements between the vessel and the floating wind turbine tower. In one example, there are two contact points over the water surface corresponding to the ends of the removable section of the upper support structure, and two contact points under the water surface near the holding means.

In one embodiment the holding means is a winch, preferably mounted on the vessel.

With reference to FIG. 24 and FIG. 25, the invention in one embodiment is a method of installing or removing a wind turbine on an anchored tension leg platform (TLP) comprising a lower support structure adapted to receive a lower end of a wind turbine tower under the water surface. The method comprising holding 102 a vessel against the floating wind turbine platform, positioning 103 a lower end of the wind turbine tower in the lower support structure under water using an outrigger on the vessel, and ballasting 104 the vessel as the weight of the wind turbine tower is transferred from the vessel to the floating wind turbine tower. The positioning 103 and the de-ballasting 104 is performed continuously until the wind turbine tower is in position in the lower support structure.

In order to hold the vessel against the floating wind turbine platform, a holding means, such as a winch or a similar device, is connected between the vessel and the floating wind turbine platform. Tension on the side facing away from the floating wind turbine platform may be provided by a construction vessel. The winch may be operated from the construction vessel. The winching operation ensures controlled approximation of the vessel towards the floating wind turbine platform. In one example, the winching operation ensures that the plurality of contact points of the vessel contacts the corresponding plurality of contact points on the floating wind turbine platform. This to minimize relative movement between the vessel and the floating wind turbine tower.

In one embodiment the method further comprises the step of removing 101, prior to positioning the lower end of the wind turbine tower in the lower support structure, a section of an upper support structure of the TLP adapted to surround and support the wind turbine tower, and reinstalling 105, after positioning the lower end of the wind turbine tower in the lower support structure, the section of the upper support structure of the TLP adapted to surround and support the wind turbine tower. This has the effect that the outrigger may enter into the center of the floating wind turbine platform.

After the installation, the vessels pulls out from the floating wind platform. The vessel may rotate by means of winch ropes and vessel movement, in order to prepare the vessel for installation of the next wind turbine tower on a different floating wind platform, thus allowing installation of a plurality of wind turbine towers on a single trip offshore. Alternatively, the first step of the process may be to remove a wind turbine tower from the floating wind platform and positioning it on the vessel, then rotate the vessel to positioning a new wind turbine tower on the floating wind platform, thus allowing replacement of a wind turbine tower offshore on a single trip offshore.

In the exemplary embodiments, various features and details are shown in combination. The fact that several features are described with respect to a particular example should not be construed as implying that those features by necessity have to be included together in all embodiments of the invention. Conversely, features that are described with reference to different embodiments should not be construed as mutually exclusive. As those with skill in the art will readily understand, embodiments incorporating any subset of features described herein and that are not expressly interdependent have been contemplated by the inventor and are part of the intended disclosure. However, explicit description of all such embodiments would not contribute to the understanding of the principles of the invention, and consequently some permutations of features have been omitted for the sake of simplicity or brevity.

1. A system comprising:
a carrier structure configured for carrying a module; and
a floating support structure configured for supporting the carrier structure,
wherein the carrier structure comprises first connection means and the floating support structure comprises second connection means, characterized in that the first and second connection means are configured for releasable connection and comprise contact surfaces that prevent the carrier structure from rotating about its longitudinal axis when the carrier structure and the floating support structure are connected.

2. The system of claim 1, wherein the first connection means comprises a plurality of first receptacles and a second connection element, and the second connection means comprises a second receptacle and a plurality of support members, and wherein the second receptacle configured for receiving the second connection element and the first receptacles are configured for receiving a corresponding one of the support structures.

3. The system of claim 2, wherein the second connection element is arranged on a portion which is dimensioned such that, when mating the carrier structure and the support structure, the second connection element is received in the second receptacle before the support posts are received in the first receptacles.

4. The system of claim 1, wherein the support structure comprises connection elements for one or more tethers, whereby the support structure may be moored to a seabed as a tension-leg platform.

5. The system of claim 1, wherein a first connection element is arranged on the carrier structure and shaped and dimensioned for releasable connection to a transportation and installation apparatus.

6. The system of claim 1, wherein the carrier structure is a wind turbine tower and the module is a generator and wind turbine.

7. A transportation and installation apparatus, configured for being arranged on a floating vessel, comprising:
a housing comprising one or more holding bays configured for releasably holding a carrier structure; and
a motion compensation mechanism configured for moving the housing with respect to the vessel about at least a pitch axis and a roll axis, and vessel heave.

8. The transportation and installation apparatus of claim 7, wherein a holding bay of the one or more holding bays is shaped and dimensioned for receiving a first connection element on the carrier structure. (Currently Amended) The transportation and installation apparatus of claim 7, wherein a holding bay of the one or more holding bays comprises a holding device whereby the carrier structure may be pulled into and secured in the holding bay.

10. A method of installing one or more carrier structures and one or more floating support structures, the method comprising:
transporting the one or more floating support structures to an installation location and mooring at least one of the one or more floating support structures to a seabed by a plurality of tethers, whereby the at least one floating support structure becomes a tension-leg platform;
transporting the one or more carrier structures to the installation location by means of a transportation and installation apparatus;
positioning at least one of the one or more carrier structures above a tethered support structure by means of the transportation and installation apparatus and operating the transportation and installation apparatus to lower the at least one carrier structure into mating engagement with the at least one floating support structure.

11. The transportation and installation apparatus of claim 7, wherein the carrier structure comprises a first connection element shaped and dimensioned for releasable connection to the transportation and installation apparatus.

12. The method of claim 10, wherein the at least one floating support structure is configured for supporting the at least one carrier structure, wherein the at least one carrier structure comprises first connection means, wherein the at least one floating support structure comprises second connection means, and wherein the first and the first and second connection means are configured for releasable connection and comprise contact surfaces that prevent the carrier structure from rotating about its longitudinal axis when the at least one floating support structure and the at least one carrier structure are connected.

13. The method of claim 12, wherein the first connection means comprises a plurality of first receptacles and a second connection element, and the second connection means comprises a second receptacle and a plurality of support members, and wherein the second receptacle is configured for receiving the second connection element and the first receptacles are configured for receiving a corresponding one of the support structures.

14. The method of claim 13, wherein the second connection element is arranged on a portion which is dimensioned such that, when mating the at least one carrier structure and the at least one support structure, the second connection element is received in the second receptacle before the support posts are received in the first receptacles.

15. The method of claim 12, wherein a first connection element is arranged on the at least one carrier structure and shaped and dimensioned for releasable connection to the transportation and installation apparatus.

16. The method of claim 10, wherein the transportation and installation apparatus comprises:
a housing comprising one or more holding bays configured for releasably holding the at least one carrier structure; and
a motion compensation mechanism configured for moving the housing with respect to the vessel about at least a pitch axis and a roll axis, and vessel heave.

17. The method of claim 16, wherein a holding bay of the one or more holding bays is shaped and dimensioned for receiving a first connection element on the at least one carrier structure.

18. The method of claim 16, wherein a holding bay of the one or more holding bays comprises a holding device whereby the at least one carrier structure may be pulled into and secured in the holding bay.
